(19) United States
(12) Patent Application Publication
(10) Pub. No.: US 2015/0258502 A1
(43) Pub. Date: Sep. 17, 2015

(54) COATING OF A POROUS SUBSTRATE FOR DISPOSITION OF GRAPHENE AND OTHER TWO-DIMENSIONAL MATERIALS THEREON

(71) Applicant: LOCKHEED MARTIN CORPORATION, Bethesda, MD (US)

(72) Inventor: David B. TUROWSKI, Palmyra, NJ (US)

(21) Appl. No.: 14/656,335

(22) Filed: Mar. 12, 2015

Related U.S. Application Data
(60) Provisional application No. 61/951,940, filed on Mar. 12, 2014.

(51) Int. Cl. B01D 69/12; B01D 69/02; B01D 67/00; B01D 71/02

(52) U.S. Cl. CPC B01D 69/12; B01D 71/021; B01D 71/025; B01D 69/02; B01D 71/027; B01D 67/0072; B01D 2325/02

(57) ABSTRACT

Composite membranes of the present disclosure can include a porous supporting substrate having a coating thereon, and one or more two-dimensional materials disposed on the coating. The coating material can include SiO₂ or various precursors thereof, which can be disposed on the porous supporting substrate by various deposition techniques. Methods for forming a composite membrane can include providing a porous supporting substrate, applying a coating on the porous supporting substrate, and disposing one or more two-dimensional materials on the coating.

### CROSS-REFERENCE TO RELATED APPLICATIONS

This application claims the benefit of priority under 35 U.S.C. §119 from U.S. Provisional Patent Application 61/951,940, filed Mar. 12, 2014, which is incorporated herein by reference in its entirety.

### STATEMENT REGARDING FEDERALLY SPONSORED RESEARCH OR DEVELOPMENT

Not applicable.

### FIELD

The present disclosure generally relates to modified surfaces and methods for their production, and, more specifically, to separation membranes formed from disposition of graphene or other two-dimensional materials on a porous substrate having a modified surface and methods for production of such composite membranes.

### BACKGROUND

Graphene represents an atomically thin layer of carbon in which the carbon atoms reside as closely spaced atoms at regular lattice positions. Synthesizing graphene in a regular lattice is difficult due to the occurrence of defects in as-synthesized two-dimensional materials. Such defects will also be equivalently referred to herein as “apertures,” “perforations,” or “holes.” Apertures can also be introduced intentionally or unintentionally following the synthesis of graphene, including during its removal from a growth substrate and handling thereafter. Aside from such apertures, graphene and other two-dimensional materials can represent an impermeable layer to many substances. Therefore, if they can be sized properly, the apertures in the impermeable layer can be useful in various applications such as filtration and separation. The term “perforated graphene” will be used herein to denote a graphene sheet with defects in its basal plane, regardless of whether the defects are natively present or intentionally produced. Despite its favorability, perforated graphene can be very difficult to handle and maintain structurally intact in the preparation of membrane structures and other filtration media.

In view of the foregoing, techniques for improving the resiliency of graphene in various applications, particularly when forming a membrane structure therefrom, would be of considerable benefit in the art. The present disclosure satisfies this need and provides related advantages as well.

### SUMMARY

In various embodiments, membranes containing a graphene layer, a graphene-based layer or other two-dimensional material upon a porous substrate are described herein, particularly porous ceramic substrates such as nanoporous ceramic substrates. More particularly, the porous substrate can have a coating thereon that reduces its surface roughness and upon which perforated graphene or other two-dimensional material is deposited. In addition, the coating can reduce the open area that the graphene or other two-dimensional material has to span, but without appreciably impacting the overall effective porosity of the substrate. In illustrative embodiments, the coating can be formed from SiO₂, which can be introduced by various deposition techniques.

In other various embodiments, methods for forming a membrane are described herein. The methods can include forming a coating, such as a SiO₂ or SiOₓ coating, on a porous substrate, and then disposing a layer of perforated graphene or other two-dimensional material on the coating.

In various embodiments, the two-dimensional material can be graphene, a graphene-based material, a transition metal dichalcogenide, molybdenum disulfide, or α-boron nitride, silicene, germanene, MXenes (e.g., M₂X, M₃X₂, M₄X₃, where M is an early transition metal such as Sc, Ti, V, Zr, Cr, Nb, Mo, Hf and Ta and X is carbon and/or nitrogen) or a combination thereof. In more particular embodiments, the two-dimensional material can be graphene or a graphene-based material. Graphene materials according to the embodiments of the present disclosure can include single-layer materials, multi-layer materials, or any combination thereof. Other nanomaterials having an extended two-dimensional, planar molecular structure can also constitute the two-dimensional material in the various embodiments of the present disclosure. For example, molybdenum disulfide is a representative chalcogenide having a two-dimensional molecular structure, and other various chalcogenides can constitute the two-dimensional material in the embodiments of the present disclosure. Choice of a suitable two-dimensional material for a particular application can be determined by a number of factors, including the chemical and physical environment into which the graphene, graphene-based or other two-dimensional material is to be deployed.

In an aspect, a composite membrane comprises a porous supporting substrate having a coating thereon; and one or more two-dimensional materials disposed on the coating.

In an embodiment, the porous supporting substrate comprises a ceramic material or a polymer material. In an embodiment, the porous supporting substrate is a ceramic material or a polymer material. For example, the porous supporting substrate or ceramic materials may be porous anodic alumina (PAA), titania (titanium dioxide, TiO₂) or silica (silicon dioxide, SiO₂).

In the composite membranes disclosed herein the porous supporting substrate may have a thickness less than or equal to 200 μm, or less than or equal to 150 μm, or less than or equal to 100 μm, or less than or equal to 75 μm, or less than or equal to 60 μm, or less than or equal to 50 μm. For example, the porous supporting substrate may have a thickness between 50 μm to 200 μm, or between 60 μm to 200 μm, or between 75 μm to 150 μm, or between 75 μm to 100 μm.

In the composite membranes disclosed herein the porous supporting substrate may have a porosity greater than or equal to 10%, or greater than or equal to 20%, or greater than or equal to 30%, or greater than or equal to 40%, or greater than or equal to 50%, or greater than or equal to 55%, or greater than or equal to 60%, or greater than or equal to 65%, or greater than or equal to 75%. For example, the porous supporting substrate may have a porosity between 10% and 75%, or between 10% and 65%, or between 10% and 60%, or between 10% and 50%, or between 10% and 40%, or between 10% and 30%, or between 10% and 20%.

In an embodiment, the coating on the porous supporting substrate comprises a material selected from the group consisting of SiO₂, TiO₂, and combinations thereof. In an embodiment, the coating is SiO₂. In an embodiment, the coating is TiO₂. In an embodiment, the coating comprises a metal oxide, such as a transition metal oxide or aluminum oxide. In an embodiment, the porous supporting substrate and the coating are different materials and have different chemical compositions.

In the composite membranes disclosed herein, the coating may have a thickness less than or equal to 100 nm, or less than or equal to 50 nm, or less than or equal to 35 nm, less than or equal to 20 nm, or less than or equal to 15 nm, or less than or equal to 10 nm, or less than or equal to 5 nm. For example, the coating may have a thickness between 5 nm to 100 nm, or between 5 nm to 50 nm, or between 5 nm to 35 nm, or between 5 nm to 20 nm, or between 5 nm to 15 nm, or between 5 nm to 10 nm.

In an embodiment, the coating is a conformal coating.

In some embodiments, the coating is disposed on at least a portion of an outer surface of the porous supporting substrate, at least a portion of an interior surface of the porous supporting substrate or at least a portion of both the outer surface and the interior surface of the porous supporting substrate. For example, at least 5%, at least 20%, at least 50%, at least 65%, at least 80%, at least 90%, or at least 95% of an outer surface of the porous supporting substrate may be covered by the coating. In an embodiment, a majority of the outer surface of the porous supporting substrate is covered by the coating. In some embodiments, at least 5%, at least 20%, at least 50%, at least 65%, at least 80%, at least 90%, or at least 95% of an interior surface of the porous supporting substrate is covered by the coating. In an embodiment, a majority of the interior surface of the porous supporting substrate is covered by the coating.

In an embodiment, the coating has a surface roughness, measured as a height difference between connected peaks and valleys on a surface or between an average peak height and an average valley height of the surface, less than or equal to 50 nm, less than or equal to 40 nm, less than or equal to 30 nm, less than or equal to 20 nm, or less than or equal to 10 nm.

In some embodiments, a composite membrane further comprises a first intermediate layer between the porous supporting substrate and the coating. For example, the first intermediate layer may be an adhesive layer, an oxide layer, a dielectric layer, a thermally insulating layer, a passivation layer, or a bonding layer.

In some embodiments, the one or more two-dimensional membranes of the composite membrane are perforated two-dimensional materials. The one or more perforated two-dimensional materials may each have an average pore size less than or equal to about 100 nm, less than or equal to about 50 nm, less than or equal to about 20 nm, less than or equal to about 10 nm, less than or equal to about 5 nm, or less than or equal to 1 nm. For example, the one or more perforated two-dimensional materials may each have an average pore size selected from a range of 1 nm to 100 nm, or 1 nm to 50 nm, or 1 nm to 20 nm, or 1 nm to 10 nm, or 1 nm to 5 nm. In some embodiments, pores of the perforated two-dimensional materials are chemically functionalized.

Exemplary two-dimensional materials suitable for use in composite membranes include but are not limited to a graphene or graphene-based film, a transition metal dichalcogenide, α-boron nitride, silicene, germanene, MXenes, carbide-derived carbons or a combination thereof. In an embodiment, the two-dimensional material has a thickness less than or equal to 20 atomic layers, or less than or equal to 10 atomic layers, or less than or equal to 5 atomic layers, or less than or equal to 2 atomic layers. In an embodiment, a composite membrane comprises at least 2 two-dimensional materials.

In an embodiment, the composite membrane further comprising a second intermediate layer between the coating and the two-dimensional material. For example, the first intermediate layer may be an adhesive layer, an oxide layer, a dielectric layer, a thermally insulating layer, a passivation layer, or a bonding layer.

In an aspect, a method for producing a composite membrane comprises: providing a porous supporting substrate; applying a coating on the porous supporting substrate; and disposing one or more two-dimensional materials on the coating.

In an embodiment, the step of providing a porous supporting substrate comprises anodizing an aluminum substrate.

In an embodiment, the step of applying a coating comprises dipping, spraying, sputtering, gas depositing or vapor depositing a coating material on the porous supporting substrate.

In an embodiment, the step of disposing a perforated two-dimensional material on the coating comprises transferring the perforated two-dimensional material using a sacrificial substrate. In another embodiment, the step of disposing a perforated two-dimensional material on the coating comprises floating the perforated two-dimensional material onto the coating while the porous supporting substrate and coating are submerged in a fluid. In yet another embodiment, the step of disposing a perforated two-dimensional material on the coating comprises dry contact transfer printing.

In an embodiment, a method for producing a composite membrane further comprises a step of perforating the one or more two-dimensional materials prior to disposing the two-dimensional materials on the coating. In an embodiment, a method for producing a composite membrane further comprises a step of perforating the one or more two-dimensional materials after disposing the two-dimensional materials on the coating.

In an aspect, a method for filtering using a composite membrane comprises: providing a composite membrane comprising a porous supporting substrate; a coating on the porous supporting substrate; and one or more two-dimensional materials on the coating, wherein the one or more two-dimensional materials are perforated two-dimensional materials; and orienting the composite membrane within a flowing fluid and perpendicular to the direction of fluid flow.

In an embodiment, a method for filtering using a composite membrane further comprises a step of applying pressure to the fluid, wherein the pressure is selected from a range of 0.5 psi to 2000 psi, or 1 psi to 1000 psi, or 5 psi to 500 psi, or 10 psi to 250 psi, or 50 psi to 250 psi.

In an embodiment, a method for filtering using a composite membrane further comprises a step of collecting a permeate after is passes through the composite membrane.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1B show illustrative images of a porous anodic alumina (PAA) surface before and after coating with SiO₂, respectively;

FIG. 2 shows an illustrative close-up image of a porous anodic alumina surface, illustrating the variance in surface topography thereon; and

FIG. 3 shows an illustrative image of the tears that can occur in a graphene sheet placed upon an uncoated porous anodic alumina substrate.

### DETAILED DESCRIPTION

The present disclosure is directed, in part, to membranes formed from disposition of graphene, graphene-based or other two-dimensional materials, particularly perforated graphene or a perforated graphene-based material, upon a porous substrate having a modified surface. The present disclosure is also directed, in part, to methods for modifying a porous substrate, upon which a graphene, graphene-based or other two-dimensional material, particularly perforated graphene or a perforated graphene-based material, is subsequently deposited. Graphene-based materials include, but are not limited to, single layer graphene, multilayer graphene or interconnected single or multilayer graphene domains and combinations thereof. In embodiments, multilayer graphene or graphene-based material includes 2 to 20 layers, 2 to 10 layers or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% or from 50% to 70%.

As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having domain sizes from 1 to 100 nm or 10-100 nm. In an embodiment, at least some of the graphene domains have a domain size greater than 100 nm up to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. A sheet of graphene-based material may comprise intrinsic defects. Intrinsic defects are those resulting unintentionally from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, the layer comprising the sheet of graphene-based material further comprises non-graphenic carbon-based material located on the surface of the sheet of graphene-based material. In an embodiment, the non-graphenic carbon-based material does not possess long-range order and may be classified as amorphous. In embodiments, the non-graphenic carbon-based material further comprises elements other than carbon and/or hydrocarbons. Non-carbon materials which may be incorporated in the non-graphenic carbon-based material include, but are not limited to, hydrogen, hydrocarbons, oxygen, silicon, copper and iron. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

As used herein, “nanoporous” refers to a property of a material where the material has pores or channels having diameters less than or equal to 100 nm extending from one surface of the material to an opposite surface of the material. The pores or channels may be substantially uniformly cylindrical or tortuous.

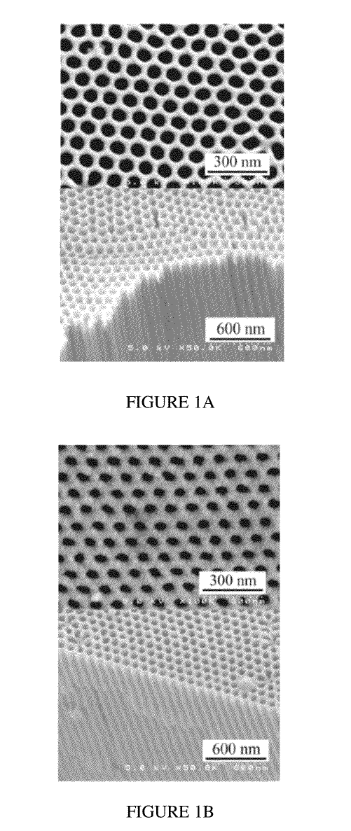

Porous and nanoporous substrates, particularly porous and nanoporous ceramic substrates, are sometimes utilized in specific applications within the medical field. Such substrates are often characterized by very high open area/porosity values (upwards of 50%) that could be beneficial in other applications, such as in desalination as a structural (buffer) substrate. That is, porous ceramic substrates represent a class of supporting materials upon which molecular filters, such as graphene, graphene-based and other two-dimensional materials, can be disposed without significantly impacting the filtration properties of the two-dimensional material. An illustrative porous ceramic substrate is porous anodic alumina, an image of which is shown in FIG. 1A.

In view of their high porosity, porous substrates, such as porous anodic alumina (PAA), have been investigated as structural substrates for disposition of graphene or graphene-based materials thereon. However, graphene and graphene-based materials have been found to be very susceptible to tearing when placed on such highly porous substrates. The large variances in the surface topography of the porous substrates resulted in tearing of the deposited graphene or graphene-based material, particularly when conducting molecular filtration therethrough. Porous substrates other than PAA, including titania, can also produce similar issues due to variances in substrate surface topography. Even within an area of approximately one micron squared, the local surface topography of ceramic and other nanoporous substrates can vary widely. Both the wide variation in local surface height as well as the ultra-thin edges of such nanoporous substrates can result in tearing of the graphene or graphene-based material, primarily due to point loading and large unsupported areas. Although the description herein is primarily directed to graphene and graphene-based materials, and particular issues associated therewith, it is to be recognized that other two-dimensional materials can present similar issues when being deposited on a porous substrate.

In response to the foregoing issues, a porous substrate may be coated to reduce the variation in its surface topography such that the incidence of tearing graphene or graphene-based material disposed thereon can be significantly reduced. More specifically, by chemically treating a porous ceramic substrate or other nanoporous substrate material with a SiO₂-forming agent, the surface topography variations can be lessened while still maintaining a high degree of porosity/open surface area. Not only can such an approach improve the surface roughness of a substrate to facilitate disposition of graphene, graphene-based or other two-dimensional materials thereon, but such surface coating with SiO₂ can further improve the structural stability of the substrate itself, thereby facilitating use in a large scale production environment. For example, PAA is a brittle material, and applying a surface coating of SiO₂ can reduce the substrate brittleness. Moreover, the coating process can selectively reduce pore diameters of the porous substrate without changing its base structure. The foregoing can also lead to less complex designs, more serviceable elements, and improved temperature and chemical sensitivity. That is, the coating processes described herein allow the pore size and chemistry to be adjusted to meet the needs of a desired end application without necessitating significant re-engineering of the substrate.

Although the embodiments described herein can be advantageous for disposition of graphene, graphene-based and other two-dimensional materials on a porous substrate, it is to be recognized that other materials can be deposited on such porous surfaces as well, while still receiving benefits from the embodiments described herein. More generally, the embodiments described herein alter the overall diameter of the pores, making the coating process a mechanism to fine tune the pore size. This can allow the use of more affordable base materials and the alteration of pore diameters to suit the particular needs of an end user. For example, by being able to tune the size and chemistry of the pores beneath an active layer, one can directly impact the performance of the active layer on top of the treated material.

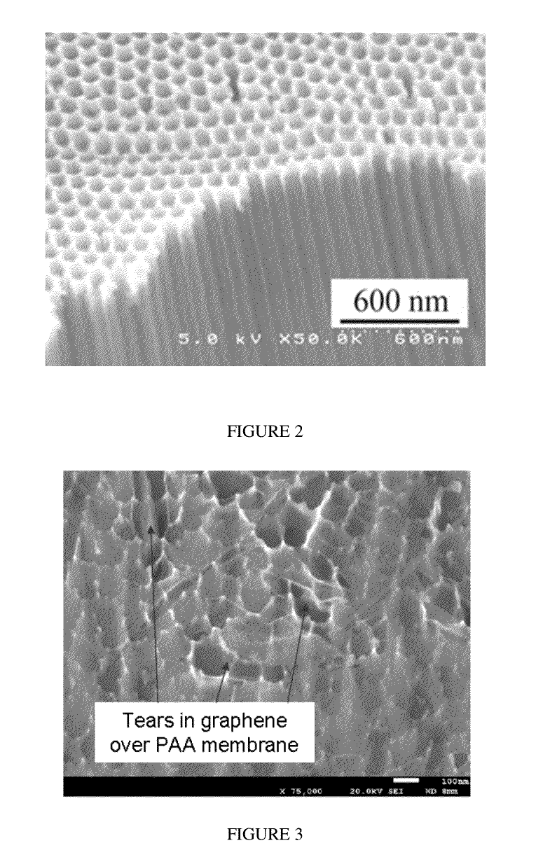

FIGS. 1A-1B show illustrative images of a porous anodic alumina surface before and after coating with SiO₂, respectively. As can be seen, the basic pore structure of the substrate remained unchanged by the coating process (FIG. 1B). FIG. 2 shows an illustrative close-up image of a porous anodic alumina surface, illustrating the variance in surface topography thereon. FIG. 3 shows an illustrative image of the tears that can occur in a graphene sheet placed upon an uncoated porous anodic alumina (PAA) substrate.

By chemically treating the pores (and the surface) of a high porosity ceramic or other porous substrate with SiO₂, the mechanical and chemical stability of the material can be increased, while offering a suitable surface atop which a selectively permeable membrane (such as a graphene-based film or other two-dimensional material) can be affixed. Although the description herein is based upon SiO₂ coating of a porous anodic alumina substrate, it is to be recognized that other coating materials and other porous substrates can be used in a related manner to provide similar effects.

In some embodiments, the treated substrate surfaces described herein can have a surface roughness, characterized by height differences between peaks and valleys, of about 50 nm or less, or 40 nm or less, or 30 nm or less, or 20 nm or less, or 10 nm or less. Such surface roughnesses can be compatible with disposition of graphene, graphene-based and other two-dimensional materials thereon, particularly perforated graphene or perforated graphene-based material. Some currently available polymer substrates (e.g., track etched polycarbonate, polyesters, polyimides, polyethersulfones, and polyvinylidenefluorides) can have a native surface roughness that is compatible with disposition of graphene or a graphene-based material thereon, but they can lack the porosity needed for graphene, graphene-based and other two-dimensional membranes to realize their full potential in separation applications. Polymer membranes can also be susceptible to chemical and thermal degradation in harsh environments. As discussed above, porous ceramic substrates can possess desirable porosity, but natively lack the surface morphology needed to effectively support graphene or a graphene-based material without damage taking place. However, ceramic membranes can possess a high degree of chemical inertness and stability over wide pH and temperature ranges. Therefore, ceramic membranes can provide a number of desirable attributes for supporting graphene, graphene-based or other two-dimensional materials in a harsh environment.

By coating the substrate material with a thin layer of SiO₂ or other suitable coating material (e.g., TiO₂), the substrate roughness can be adjusted into a regime that is suitable for disposition of graphene, graphene-based or other two-dimensional materials thereon. The coating technique is not particularly limited and can include such techniques as gas phase deposition, solution coating, sol-gel processes, and the like. In more particular embodiments, deposition of a SiO₂ coating can be achieved through various adsorption, hydrolysis and washing processes, More specifically, deposition of a SiO₂ coating can be achieved by contact of the surface with a SiO₂ precursor, a silicon-containing precursor, such as a silicon halide or an organosilane or silicate, followed by hydrolysis to complete formation of the SiO₂. In some embodiments, a similar process can be employed using a TiO₂ precursor, such as titanium tetrachloride or titanium alkoxides. Thereafter, drying of the coated substrate can take place, such as in a stream of argon or nitrogen. As needed, the deposition operations can be repeated one or more times to build up or thicken the surface and pore walls to ensure adequate coverage with a more uniform surface topography. The coated substrate can then be cycled through a heating process that heat treats or anneals the coating material to further increase its strength. In illustrative embodiments, the thickness of the coating is about 10 μm, or about 5 μm, or about 2 μm, or between 10 μm and 2 μm. In specific embodiments, sol-gel processes can be employed to prepare SiO₂ or TiO₂ coatings.

In various embodiments, the porous substrate can have a native porosity (i.e., open area) of about 20% or above, or about 25% or above, or about 30% or above, or about 35% or above, or about 40% or above, or about 45% or above, or about 50% or above. In various embodiments, the native porosity of the porous substrate can be reduced by about 5% or less when coated as described herein. In other various embodiments, the native porosity of the porous substrate can be reduced by about 30% or less when coated as described herein.

The technique used for forming the graphene or graphene-based material in the embodiments described herein is not believed to be particularly limited. For example, in some embodiments CVD graphene or graphene-based material can be used. In various embodiments, the CVD graphene or graphene-based material can be liberated from its growth substrate (e.g., Cu) and transferred to the coated porous substrate. Likewise, the techniques for introducing perforations to the graphene or graphene-based material are also not believed to be particularly limited, other than being chosen to produce perforations within a desired size range. Illustrative perforation techniques can include plasma treatment and particle bombardment.

Perforations are sized to provide desired selective permeability of a species (molecule, ion, etc.) for a given application. Selective permeability relates to the propensity of a porous material or a perforated two-dimensional material to allow passage (or transport) of one or more species more readily or faster than other species. Selective permeability allows separation of species which exhibit different passage or transport rates. In two-dimensional materials selective permeability correlates to the dimension or size (e.g., diameter) of apertures and the relative effective size of the species. Selective permeability of the perforations in two-dimensional materials, such as graphene-based materials, can also depend on functionalization of perforations (if any) and the specific species that are to be separated. Separation of two species in a mixture includes a change in the ratio (weight or molar ratio) of the two species in the mixture after passage of the mixture through a perforated two-dimensional material.

### Example 1

### Porous Anodic Alumina (PAA) Synthesis

Porous anodic alumina (PAA) may be synthesized by the two-step anodization process disclosed in Vajandar et al., Nanotechnology, 18 (2007) 275705, which is incorporated by reference herein in its entirety for description of this method and the properties of the resultant PAA. where aluminum films were first anodized to form oxide, and then the oxide was stripped and the aluminum anodized again. After the anodization steps, the remaining aluminum layer underneath the oxide was dissolved, followed by barrier layer dissolution and pore widening to give a free-standing PAA membrane.

An aluminum sheet (99.99% purity) was degreased and cleaned by rinsing in acetone prior to immersion in the electrolyte solution for anodization. Some commonly used electrolytes for anodizing aluminum are sulfuric acid, phosphoric acid, oxalic acid and chromic acid. However, to produce alumina with a highly ordered cell configuration appropriate anodization conditions need to be used, i.e., the two-step anodization process. The first anodization step was carried out in 0.3 M oxalic acid solution at a constant voltage of 40 V for 5 hours. The temperature of the electrolyte was maintained at 15° C. using a cold plate under constant stirring to remove the heat evolved from anodization. The oxide so formed was dissolved in an etching solution comprising 18 wt. % chromic acid and 6 wt. % phosphoric acid at 60° C. for 3 hours, which resulted in the formation of a periodic concave texture on the aluminum surface. This textured pattern acts as self-assembled marks inducing the ordered formation of pores for the second anodization step. The second anodization step was carried out using identical conditions as those used for the first step but for a longer period of 16-17 hours, resulting in an ideally arranged honeycomb structure. The long anodization time improved the regularity of cell arrangement as well as reduced the number of defects and dislocations. The bottom aluminum layer was etched away in a saturated solution of mercury chloride, leaving behind the as-fabricated membrane. Following this the barrier layer (also made of alumina) present at the bottom of the membrane was chemically etched and the pore size increased by immersing the as-fabricated membrane in 5 wt. % phosphoric acid solution at 30° C. for approximately 70 minutes. The pore diameter and length/thickness were 80±5 nm and 90±5 μm, respectively. The porosity of the as-fabricated membrane after the pore widening treatment was calculated to be about 50%.

### Example 2

### Coating PAA with SiO₂

PAA, fabricated according to Example 1, was coated with a layer of SiO₂ according to the methods described in S. K. Vanjandar, Electro-Osmotic Pumping and Ionic Conductance Measurements in Porous Membranes, Dissertation, Vanderbilt University, Nashville, Tenn., 2009, which is incorporated by reference herein in its entirety for description of this method and the properties of the resultant coated PAA. The PAA was coated using a surface sol-gel synthesis technique involving adsorption, hydrolysis and washing of each aluminum oxide membrane spanned over seven steps. Each membrane was taken through five cycles of the coating process to ensure that the inner wall of the pore was completely covered with the silica layer. The thickness of the PAA membranes after the coating process was still 90±5 μm but the pore diameter was reduced to 70±5 nm.

In an exemplary embodiment, each membrane was fully contacted with silicon tetrachloride (SiCl₄), as a solution in carbon tetrachloride (CCl₄) (40:60 by volume) allowing reaction with the PAA surface and pores, followed by washing in CCl₄ to remove non-reacted SiCl₄ from the PAA surface. The PAA was then contacted again with carbon tetrachloride to remove unbound SiCl₄ from pores. The PAA was immersed in a mixture of CCl₄/Methanol (1:1 by volume) and then immersed in ethanol to remove CCl₄ The treated PAA was then dried in a stream of inert gas (argon) to remove ethanol. The membrane was then fully contacted with deionized (D.I.) water to complete the hydrolysis of SiCl₄ to SiO₂. The PAA was then immersed in methanol and dried in an inert gas stream (argon) to remove methanol. Various steps of the procedure can be conducted for 5-30 minutes or more as needed. It will be appreciated by those of ordinary skill in the art that precursors other than SiCl₄ can be employed for deposition of SiO₂ coatings.

### Example 3

### Disposing Graphene or Graphene-Based Material on SiO₂ Coated PAA

Graphene or graphene-based material may be disposed upon SiO₂-coated PAA, fabricated according to Examples 1 and 2, using a direct transfer technique such as dry contact transfer printing, which is described for example in U.S. Provisional Application No. 61/951,930, filed Mar. 12, 2014, and its corresponding U.S. Non-Provisional application [docket no. 565650: 154-14], a floating technique and/or a sacrificial substrate technique, which are both disclosed in U.S. patent application Ser. No. 14/609,325, filed Jan. 29, 2015 [docket no. 563878: 161-14]. All of these patent applications are incorporated by reference herein in their entireties for description of methods of transferring graphene or graphene-based materials from growth substrates.

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomer and enantiomer of the compound described individually or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention.

Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

1. A composite membrane comprising:
a porous supporting substrate having a coating thereon; and
one or more two-dimensional materials disposed on the coating.

2. The composite membrane of claim 1, wherein the porous supporting substrate comprises a ceramic material or a polymer material.

3. The composite membrane of claim 1, wherein the porous supporting substrate comprises porous anodic alumina (PAA), titania or silica.

4. The composite membrane of claim 1, wherein the porous supporting substrate has a thickness less than or equal to 60 μm.

5. The composite membrane of claim 1, wherein the porous supporting substrate has a thickness between 60 μm to 200 μm.

6. The composite membrane of claim 1, wherein the porous supporting substrate has a porosity greater than or equal to 10%.

7. (canceled)

8. The composite membrane of claim 1, wherein the coating comprises a material selected from the group consisting of SiO₂, TiO₂ and combinations thereof.

9. The composite membrane of claim 1, wherein the coating has a thickness less than or equal to 5 nm.

10. The composite membrane of claim 1, wherein the coating has a thickness between 5 nm to 50 nm.

11. The composite membrane of claim 1, wherein the coating is a conformal coating.

12. The composite membrane of claim 1, wherein the coating is disposed on at least a portion of an outer surface of the porous supporting substrate, at least a portion of an interior surface of the porous supporting substrate or at least a portion of both the outer surface and the interior surface of the porous supporting substrate.

13. (canceled)

14. (canceled)

15. The composite membrane of claim 1, wherein the coating has a surface roughness less than or equal to 50 nm.

16. The composite membrane of claim 1 further comprising a first intermediate layer between the porous supporting substrate and the coating.

17. The composite membrane of claim 1, wherein the one or more two-dimensional materials are perforated two-dimensional materials.

18. The composite membrane of claim 17, wherein the one or more perforated two-dimensional materials each have an average pore size less than or equal to 1 nm.

19. The composite membrane of claim 17, wherein the one or more perforated two-dimensional materials each have an average pore size selected from a range of 1 nm to 10 nm.

20. The composite membrane of claim 17, wherein pores of the perforated two-dimensional materials are chemically functionalized.

21. The composite membrane of claim 1, wherein the two-dimensional material comprises a graphene or graphene-based film, a transition metal dichalcogenide, α-boron nitride, silicene, germanene, MXenes, carbide-derived carbons or a combination thereof.

22. The composite membrane of claim 1, wherein the two-dimensional material has a thickness less than or equal to 20 atomic layers.

23. The composite membrane of claim 1 further comprising a second intermediate layer between the coating and the two-dimensional material.

24. The composite membrane of claim 1 comprising at least 2 two-dimensional materials.

25. A method for producing a composite membrane comprising:
providing a porous supporting substrate;
applying a coating on the porous supporting substrate; and
disposing one or more two-dimensional materials on the coating.

26. The method of claim 25, wherein the step of providing a porous supporting substrate comprises anodizing an aluminum substrate.

27. The method of claim 25, wherein the step of applying a coating comprises dipping, spraying, sputtering, gas depositing or vapor depositing a coating material on the porous supporting substrate.

28. The method of claim 25, wherein the step of disposing a perforated two-dimensional material on the coating comprises transferring the perforated two-dimensional material using a sacrificial substrate.

29. The method of claim 25, wherein the step of disposing a perforated two-dimensional material on the coating comprises floating the perforated two-dimensional material onto the coating while the porous supporting substrate and coating are submerged in a fluid.

30. The method of claim 25, wherein the step of disposing a perforated two-dimensional material on the coating comprises dry contact transfer printing.

31. The method of claim 25 further comprising a step of perforating the one or more two-dimensional materials prior to disposing the two-dimensional materials on the coating.

32. The method of claim 25 further comprising a step of perforating the one or more two-dimensional materials after disposing the two-dimensional materials on the coating.

33. A method for filtering using a composite membrane comprising:
providing a composite membrane comprising a porous supporting substrate; a coating on the porous supporting substrate; and one or more two-dimensional materials on the coating, wherein the one or more two-dimensional materials are perforated two-dimensional materials; and
orienting the composite membrane within a flowing fluid and perpendicular to the direction of fluid flow.

34-40. (canceled)

41. The method of claim 33 further comprising a step of applying pressure to the fluid, wherein the pressure is selected from a range of 0.5 psi to 2000 psi.

42. (canceled)
